(19) United States
(12) Patent Application Publication
(10) Pub. No.: US 2012/0288060 A1
(43) Pub. Date: Nov. 15, 2012

(54) METHOD AND SYSTEM FOR INSPECTING OBJECTS, PARTICULARLY ITEMS OF LUGGAGE

(76) Inventor: Knut BENEKE, Ober-Olm (DE)

(21) Appl. No.: 13/493,257

(22) Filed: Jun. 11, 2012

Related U.S. Application Data
(63) Continuation of application No. PCT/EP2010/006491, filed on Oct. 23, 2010.

(30) Foreign Application Priority Data
Dec. 9, 2009 (DE) DE102009057386.0

(51) Int. Cl. G01N 23/04

(52) U.S. Cl. 378/57

(57) ABSTRACT

A method for checking objects, particularly items of luggage, in which the objects are transported by means of a conveyor device through a checking appliance in which they are irradiated with electromagnetic radiation from at least one radiation source and radiation modified by the object is detected by means of a detector arrangement, and in which an evaluation unit takes the detected radiation and produces an image of the object which is displayed on a screen and, during the display, is at least intermittently moved in the direction of conveyance of the object across the screen, wherein the image of the object is displayed on a hold-type display, particularly an LCD, TFT or OLED screen, and an image moved across the display is shown in a form sharpened by predistortion of movement in order to reduce blurring of the image during viewing.

This nonprovisional application is a continuation of International Application No. PCT/EP2010/006491, which was filed on Oct. 23, 2010, and which claims priority to German Patent Application No. DE 10 2009 057 386.0, which was filed in Germany on Dec. 9, 2009, and which are both herein incorporated by reference.

### BACKGROUND OF THE INVENTION

1. Field of the Invention

The invention relates to a method and a system for inspecting objects, particularly items of luggage, in which the objects are transported by means of a conveying device through an inspection device, in which they are irradiated with electromagnetic radiation from at least one radiation source and radiation modified by the object is detected by means of a detector array. An image of the object, which is displayed on a screen and viewed by an operator for inspection, is generated by an evaluation unit from the detected radiation.

2. Description of the Background Art

Inspection typically occurs by means of x-rays and during a display the generated x-ray image is moved across the screen intermittently in the direction of conveyance of the object, therefore horizontally. Thus, the display keeps pace with the speed at which the inspection object is conveyed through the inspection device. As is well known, the security inspection of items of luggage is carried out at airports in this way. A method of this type and a system of this type are described in DE 10 2005 011 054, which corresponds to U.S. Pat. No. 8,165,267, which is incorporated herein by reference.

In the past, customary cathode ray tubes were used as screens for displaying images; these have been replaced meanwhile in many applications by screens with a liquid crystal display (LCD screens), because these have a lower space requirement and a lower weight. Because of their improved contrast, LCD screens with thin film transistors, so-called TFT screens, are used preferentially.

In the display of images in x-ray inspection systems, the generated images must be shown not only while stationary but also moving horizontally across the screen and also be evaluated in motion by an operator. The display of the x-ray image occurs, on the one hand, in step with the speed with which the item of luggage is conveyed through the system, but, on the other, an operator can stop the image in order to check details in a stationary state.

In the case of screens, which are designed as so-called hold-type displays, the problem now occurs that a moving image appears blurred and fuzzy to a viewer, because the state of a pixel is retained for the duration of an image period until a new image is formed. This effect called motion blur arises because the viewer's eye when tracking a moving image integrates its brightness over a specific period whereas the image content remains fixed. This leads to blurring of the image on the viewer's retina. Hold-type displays are LCD, TFT, and OLED screens with organic light-emitting diodes. DLP projectors likewise tend to blur moving images.

When hold-type screens are used in x-ray inspection systems, an aggravating circumstance is that the stationary image appears sharp and thereby an alternation between a sharp and blurred display occurs in the case of each gap between two objects and with each stopping and restarting of the conveying device. This alternation is extremely irritating to the human observer. The eye tries in vain to compensate for the change in sharpness and in so doing tires very rapidly.

Because the intensity of the motion blur is predetermined solely by the length of the displacement of the moving object during a single image display on the screen, various countermeasures can be taken to reduce the blur: Thus, an increase in the screen refresh rate leads to a reduction in the blurring. It is also possible to reduce the blurring by slowing the movement. Both approaches rapidly reach their limits, because flat screens with sufficiently high refresh rates are not available. Even if a sufficiently high refresh rate were to be realized, control by the high refresh rate and the thereby very high data transfer rate would be problematic. Slowing of the movement of the inspection objects is also difficult to realize in a luggage inspection system, because the movement of the objects through the conveying device is predetermined.

### SUMMARY OF THE INVENTION

It is therefore an object of the invention to improve a method and a system of the generic type, so that it is possible to use flat screens with a sufficient sharpness of both stationary images and images shown as moving.

This object is attained according to the invention in that the image of the object is displayed on a hold-type display, particularly an LCD, TFT, or OLED screen, and an image moving across the screen is shown sharpened by predistortion in the direction of movement in order to reduce blurring of the image during viewing.

According to an embodiment of the invention, the circumstance is used that the movement of the objects and thereby the images in the case of a luggage inspection system occurs in only one direction and is well-known. Preferably, during the inspection the object moves steadily through the inspection device. While the object is irradiated, for example, x-rayed, the generated image on the screen also moves uniformly in the conveyor belt direction. If no objects to be inspected are being conveyed or in the case of a stationary conveying device, the image is also fixed. This scenario makes it possible to minimize the motion blur of a moving image by a predistorted sharpened display.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows the basic structure of the device according to an embodiment;

FIG. 2 shows a blurred image in a stationary state of the section of the x-ray image of the suitcase;

FIG. 3 shows a blurred image during movement of the section of the x-ray image of the suitcase, therefore a moving display on the screen.

FIG. 4 shows a stationary sharpened image of the section of the x-ray image of the suitcase; and

FIG. 5 shows a moving display of a sharpened image of the section of the x-ray image of the suitcase.

### DETAILED DESCRIPTION

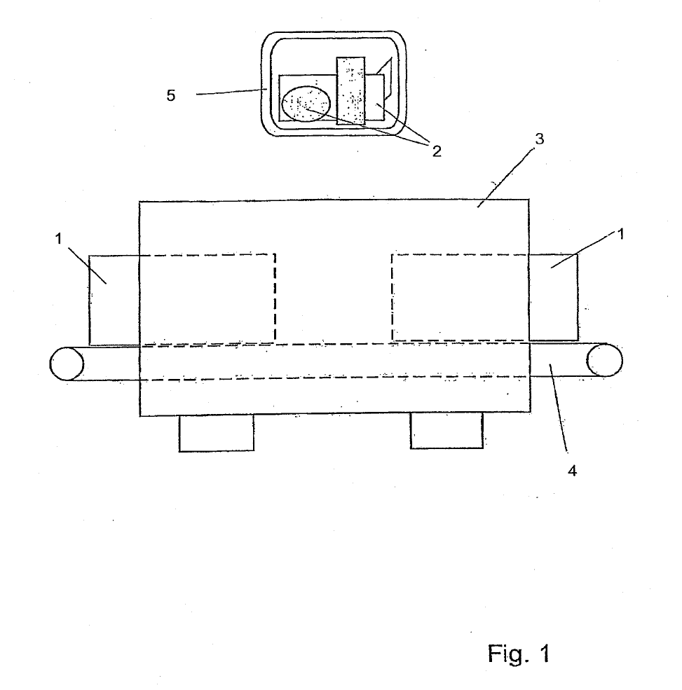

The inspection system depicted in FIG. 1 is used for the security inspection of objects 1, particularly pieces of luggage, as it is carried out at airports. In the security inspection, articles 2 located in the items of luggage are inspected in regard to their security relevance.

The system contains as an essential component an inspection device 3 having at least one stationary radiation source, preferably an x-ray source, and at least one assigned detector array, by which the intensity of the radiation modified by object 1 is measured.

Objects 1 can be x-rayed by rays emitted in at least one fan-shaped radiation plane at which a detector array is oriented. The detector array detects the radiation penetrating object 1 and not absorbed by object 1. Alternatively, the intensities of the rays scattered by an object 1 can also be detected.

Objects 1 are transported by means of a conveying device 4, preferably a belt conveyer, through inspection device 3, in which they are irradiated with electromagnetic radiation, preferably with x-radiation. Preferably, conveying device 4 is driven so that it conveys objects 1 horizontally and at a uniform speed through inspection device 3.

Further, the system contains an evaluation unit with a computer and a screen 5, on which the images, generated by the evaluation unit from the detected radiation, of objects 1 and the articles 2 located therein are displayed for visual examination by an operator. During the display on screen 5, an image is moved across screen 5 at least intermittently also at a uniform speed so that it keeps pace with the conveying speed of object 1. It is thus made possible that the particular images of objects 1 are displayed according to their passage through inspection device 3. It is likewise possible for the operator to stop an image for a desired time for a detail inspection in a stationary image.

The display of the x-ray image of an object 1 occurs on a flat screen 5, which is designed as a hold-type display. Preferably, the display occurs as in the exemplary embodiment on a TFT screen; likewise the use of a different LCD screen or an OLED screen or also a DLP projector is possible, even if these displays tend more or less to blur during the display of moving images.

To reduce blurring of the image during viewing on TFT screen 5 or another screen type, an algorithm is stored in the evaluation unit; said algorithm sharpens an image moving across the screen by predistortion, in order to reduce blurring of the image during viewing by means of a sharpened display on screen 5.

For simplification, preferably each image, no matter whether stationary or moving, is sharpened in the direction of movement. This method results in a compensation of the blurring in the viewer's eye, because the blurring corresponds approximately to a low pass in direction of movement.

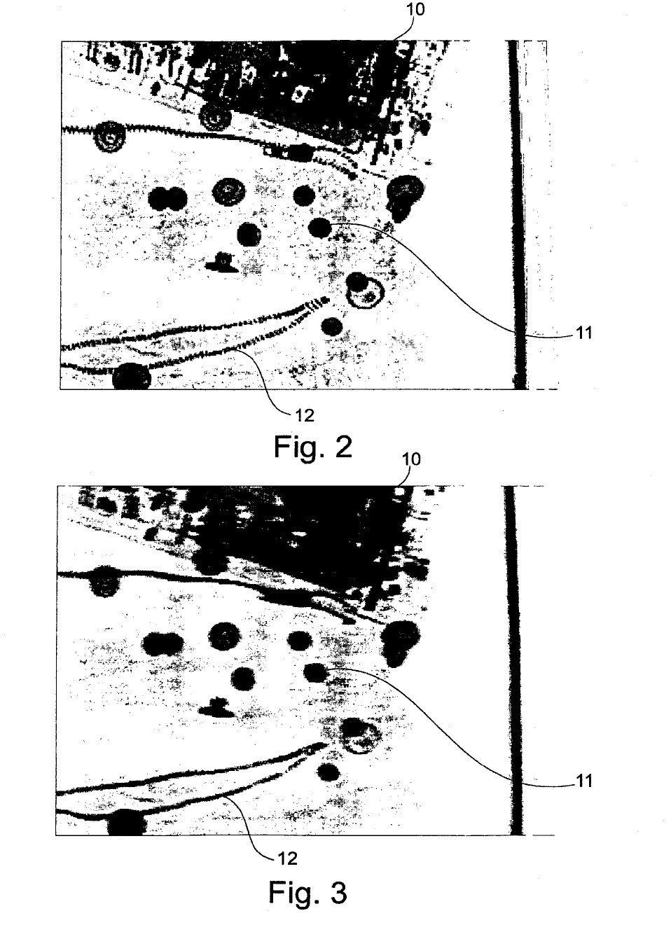

Sections of an x-ray image of a suitcase are shown as examples in FIGS. 2-5. Parts of a radio 10 can be seen at the top, metal buttons 11 and zippers 12 at the bottom, and the suitcase edge on the right.

FIG. 2 shows a blurred stationary x-ray image. FIG. 3 shows the same section, as an operator would see on a moving display on a TFT screen. It becomes clear, for example, at metal zippers 12 that the image is seen blurred.

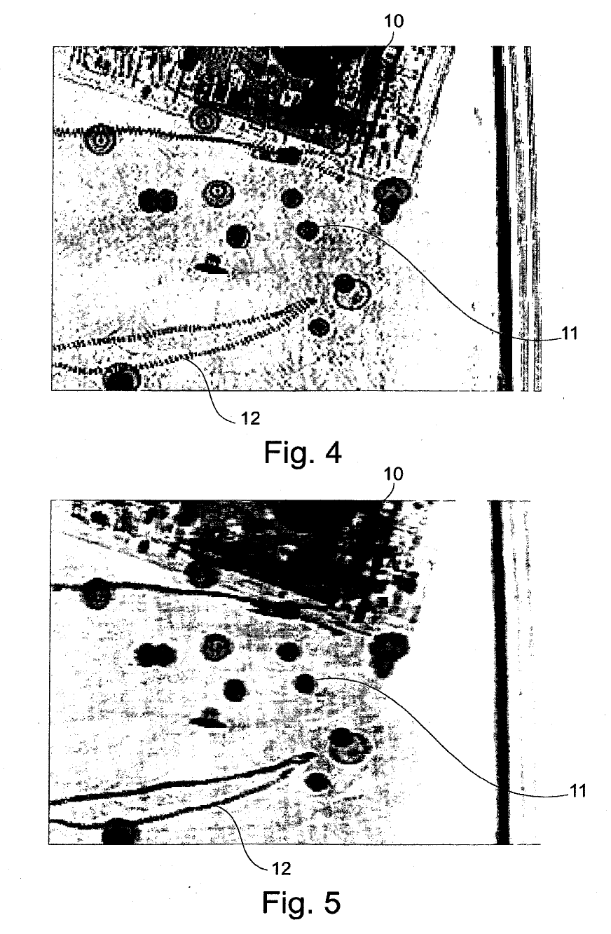

The same image sections as in FIGS. 2 and 3 are shown in FIGS. 4 and 5. The images in FIGS. 4 and 5 are sharpened by predistortion in the direction of movement. In the stationary image in FIG. 4, therefore, perpendicular edges emerge more intensely. FIG. 5 shows the perceived image in a moving display, as an operator would observe during the movement. It can be seen in FIG. 5 that fewer details are lost in the sharpened image during the moving display on TFT screen 5. Thus, for example, the teeth of zippers 12 remain visible. Overall, the image has a sharper effect and the difference between the stationary and moving image display is smaller.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for inspecting objects, the method comprising:
transporting the objects via a conveying device through an inspection device, the objects being are irradiated with electromagnetic radiation from at least one radiation source;
detecting radiation modified by the object via a detector array;
generating an image of the object by an evaluation unit based on the detected radiation, the image being displayed on a screen and during the display is moved across the screen at least intermittently in a direction of conveyance of the object; and
displaying the image of the object on a hold-type display, an LCD, TFT, or OLED screen,
wherein an image moving across the display in the direction of movement is shown sharpened by predistortion in order to reduce blurring of the image during viewing.

2. The method according to claim 1, wherein an object is conveyed at a uniform speed through the inspection device, and wherein, during the display, the image is accordingly moved at a uniform speed across the display.

3. The method according to claim 1, wherein the object is irradiated for inspection by x-rays.

4. The method according to claim 1, wherein the detector array detects rays penetrating the object and not absorbed by the object.

5. The method according to claim 1, wherein radiation scattered by the object is detected.

6. A system for carrying out a method according to claim 1, the system comprising
a conveying device via which the objects to be inspected are transported through an inspection device, the inspection device having at least one radiation source for irradiating the objects with electromagnetic radiation and a detector array for detecting the radiation modified by the object;
an evaluation unit, which generates an image of the object from the detected radiation; and
a screen for displaying the generated image,
wherein the screen for displaying the generated image is a hold-type display, an LCD, TFT, or OLED screen, and
wherein the evaluation unit contains an algorithm, which sharpens an image moving across the screen in the direction of movement by predistortion in order to reduce blurring of the image during viewing by a sharpened display on the screen.

7. The system according to claim 6, wherein an object is conveyed at a uniform speed through the inspection device and accordingly the image is moved during the display at a uniform speed across the screen.

8. The system according to claim 6, wherein the radiation source is an x-ray source.

9. The system according to claim 6, wherein the radiation penetrating the object and not absorbed by the object is detected by the detector array.

10. The system according to claim 6, wherein the detector array detects radiation scattered by the object.

11. The method according to claim 1, wherein the objects are items of luggage.
